(19) United States
(12) Patent Application Publication
(10) Pub. No.: US 2006/0182132 A1
(43) Pub. Date: Aug. 17, 2006

(54) Local switching method using logical link ID in Ethernet passive optical network system

(75) Inventors: Su-Hyung Kim, Seoul (KR); Tae-Sung Park, Yongin-si (KR); Seong-Ha Kim, Yongin-si (KR); Chang-Sup Shim, Seoul (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/353,660

(22) Filed: Feb. 14, 2006

(30) Foreign Application Priority Data
Feb. 14, 2005 (KR) 12087/2005

(51) Int. Cl. H04L 12/56

(52) U.S. Cl. 370/401

(57) ABSTRACT

A local switching method using a logical link ID (LLID) in an Ethernet passive optical network (EPON) system is disclosed. The local switching method includes a first step of an optical network unit (ONU) receiving and separating data inputted through a user port into a wide area network (WAN) traffic and a local area network (LAN) traffic, allocating the LLID according to a service for each traffic to the separated WAN traffic and LAN traffic, and transmitting the WAN traffic and LAN traffic with the LLIDs allocated thereto; and a second step of an optical line termination (OLT) receiving the WAN traffic and LAN traffic with the LLIDs allocated thereto transferred from the ONU, extracting a destination of the corresponding traffic through the LLIDs, and transmitting the respective traffic accordingly.

### CLAIM OF PRIORITY

This application claims priority to an application entitled “Local Switching Method Using Logical Link ID in Ethernet Passive Optical Network System,” filed in the Korean Intellectual Property Office on Feb. 14, 2005 and assigned Serial No. 2005-12087, the contents of which are hereby incorporated by reference

### BACKGROUND OF THE INVENTION

1. Field of the Invention

The present invention relates an Ethernet passive optical network (EPON) system, and more particularly to a method for providing a local switching in an EPON system.

2. Description of the Related Art

A passive optical network (PON) system is defined by a distribution topology of a tree-like structure having a plurality of optical network units (ONUs) coupled to an optical line termination (OLT) using a 1×N optical distribution network (ODN). This PON system may be classified into an EPON, GPON, CDMA-PON, WDM-PON, and others.

In the current EPON system, a user of an ONU cannot communicate with another user associated with the same OLT. This is because it is impossible to retransmit frames, which have been transmitted to an input port, to the same port, according to the Ethernet protocol that is the basis of the EPON. In order to solve this, a method of separating subscribers into virtual LANs (VLANs) in a Layer 3 (L3) function using an L3 switch provided at an upper end of the OLT in the EPON has been researched.

FIG. 1 is a view illustrating the construction of a conventional EPON system using an L3 switch, in which OLT 12 is connected to a plurality of ONUs 13-1 to 13-n, and each of the ONUs 13-1 to 13-n is provided with a user port.

The OLT 12 transmits/receives data to/from the ONUs 13-1 to 13-n. Here, the data includes LAN traffic 102-1, 102-n, 131-1, 131-2, 131-3, 131-4 and 131-5 for short-distance communications, and wide area network (WAN) traffic 101-1, 103-1, 101-n and 103-n for long-distance communications.

As described above, the transmission of the LAN traffic 131-1, 131-2, 131-3, 131-4 and 131-5 for communications with ONUs in the OLT 12, among the LAN traffic 102-1, 102-n, 131-1, 131-2, 131-3, 131-4 and 131-5 cannot be performed due to the limitations in the Ethernet communication design.

Accordingly, the LAN traffic 102-1, 102-n, 131-1, 31-2, 131-3, 131-4 and 131-5, and the WAN traffic 101-1, 103-1,101-n and 103-n are transmitted to an outside of the OLT 12 (113 and 114), re-inputted to the OLT 12 by being switched through an external Layer 3 (L3) switch 11 for subsequent transmissions to the respective ONUs.

However, the operation of the L3 switch located outside the OLT as described above is not desirable in terms of its operation and the efficient usage of an Internet protocol (IP). Accordingly, the transfer of the LAN traffic within the OLT should be performed in other improved ways. A new device must be developed, and in order for such hardware to be added to the EPON system, the hardware logic of the whole EPON system must be changed. Further, there is a need for securing a quality of service (QoS) for internal traffic in an EPON local switching environment when performing the transfer of the LAN traffic.

### SUMMARY OF THE INVENTION

Accordingly, the present invention has been designed to solve the above and other problems occurring in the prior art and further provides additional advantages, by providing a local switching method using a logical link ID (LLID) in an EPON system that can implement a local switching function through a software change in the EPON system, by allocating the LLID to the respective traffic in an ONU, and secure the QoS for the locally switched traffic.

In one embodiment, there is provided a local switching method using a logical link ID (LLID) in an Ethernet passive optical network (EPON) system, which includes a first step of an optical network unit (ONU) receiving and separating data inputted through a user port into a wide area network (WAN) traffic and a local area network (LAN) traffic, allocating the LLID according to a service for each traffic to the separated WAN traffic and LAN traffic, and transmitting the WAN traffic and LAN traffic with the LLIDs allocated thereto; and a second step of an optical line termination (OLT) receiving the WAN traffic and LAN traffic with the LLIDs allocated thereto transferred from the ONU, extracting a destination of the corresponding traffic through the LLIDs, and transmitting the respective traffic accordingly.

### BRIEF DESCRIPTION OF THE DRAWINGS

The above features and advantages of the present invention will be more apparent from the following detailed description taken in conjunction with the accompanying drawings, in which:

FIG. 1 illustrates the construction of an exemplary conventional EPON system using an L3 switch;

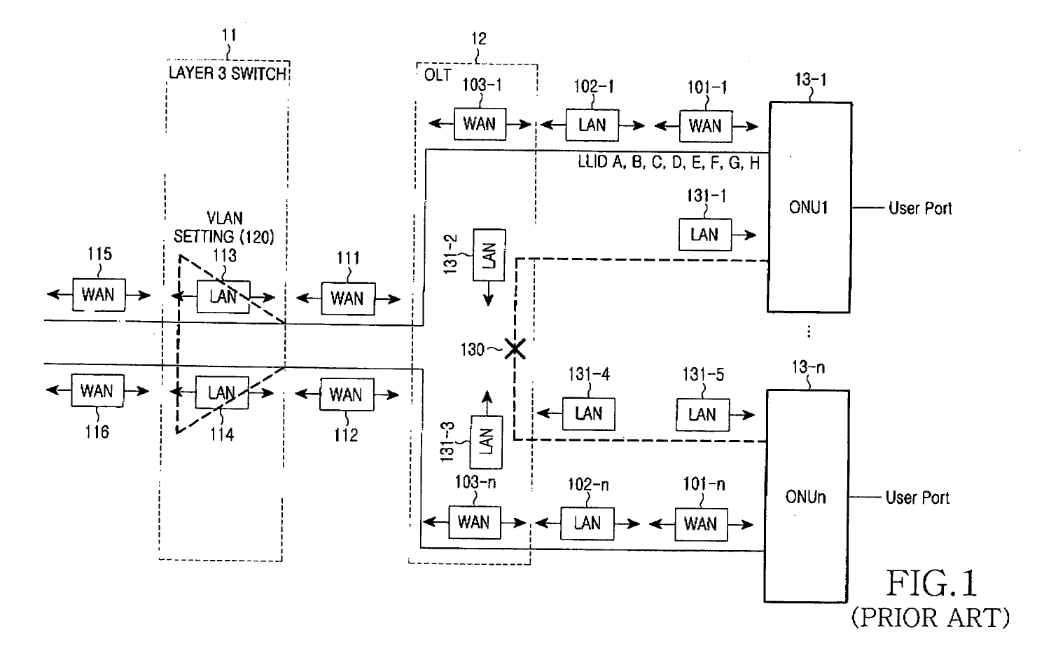

FIG. 2 is a view illustrating the construction of an EPON system to which a local switching method using an LLID is applied according to an embodiment of the present invention;

FIG. 3 is a view illustrating a detailed construction of an ONU in the EPON system to which a local switching method using an LLID is applied according to an embodiment of the present invention;

FIG. 4 is a flowchart illustrating a local switching method using an LLID of an ONU in an EPON system according to an embodiment of the present invention; and

FIG. 5 is a flowchart illustrating a local switching method using an LLID of an OLT in an EPON system according to an embodiment of the present invention.

### DETAILED DESCRIPTION

Hereinafter, embodiments of the present invention will be described in detail with reference to the accompanying drawings. For the purposes of clarity and simplicity, a detailed description of well-known functions and configurations incorporated herein will be omitted as it may obscure the subject matter of the present invention.

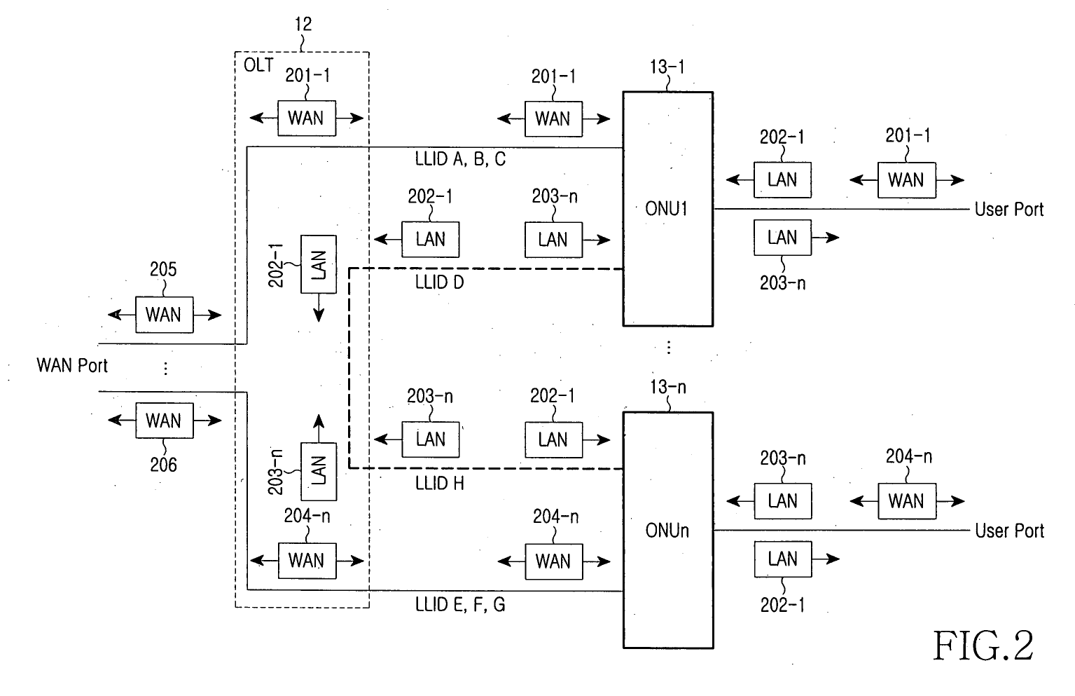

FIG. 2 is a view illustrating the construction of an EPON system to which a local switching method using an LLID is applied according to an embodiment of the present invention.

As shown, OLT 12 is connected to a plurality of ONUs 13-1 to 13-n, and each of the ONUs 13-1 to 13-n is provided with a user port.

In operation, the OLT 12 transmits/receives data to/from the ONUs 13-1 to 13-n, and the data includes LAN traffic 202-1 and 203-n for short-distance communications as well as WAN traffic 201-1 and 204-n for long-distance communications.

Briefly, the EPON system using the LLID according to the present invention separates the LAN traffic 202-1 and 203-n and the WAN traffic 201-1 and 204-n inputted through a user port using a classification function of the ONU, and transmits the separated traffic to different ports.

The EPON system allocates LLIDs to the WAN traffic and the LAN traffic according to the type of the traffic. That is, the WAN traffic and the LAN traffic inputted to the user ports of the ONUs 13-1 and 13-n are separated into the WAN traffic and the LAN traffic according to the classification functions of the ONUs 13-1 and 13-n, and transmitted to the OLT 12 through different ports.

The OLT 12 has a self routing table for a traffic transmission, and performs a routing of the WAN traffic 201-1 and 204-n transmitted to the OLT 12 using the routing table. Particularly, if no corresponding destination exists in the routing table in the case of the WAN traffic, the OLT 12 transfers the WAN traffic to an upper WAN interface (205), and transmits the LAN traffic to an address of another ONU that is registered in the corresponding routing table to the destination in the case of the LAN traffic 202-1 and 203-n, so as to perform a local switching operation.

In this case, in order to secure the QoS of the LAN traffic 202-1 and 203-n, the ONUs 13-1 and 13-n can prevent a packet loss with respect to a specified traffic by separating the traffic using the classification function and allocating specified queues to the respective traffic. Also, since it is possible to allocate weight values of a dynamic bandwidth allocation (DBA), which is one of band allocation methods of the EPON system, to the specified traffic during an upper transmission, this function can be used for the traffic that require the security of QoS.

The reason that the ONUs allocate specified queues to the traffic and assign the weight value of DBA is that the characteristics of the traffic can be recognized by the OLT 12 by separating the respective traffic and allocating the LLIDs to the traffic separated according to the classification.

In addition, in the case of transmitting down-data, it is possible to secure the QoS through the DBA weight value allocation and the specified queue allocation in the same manner as the case of transmitting up-data as described above.

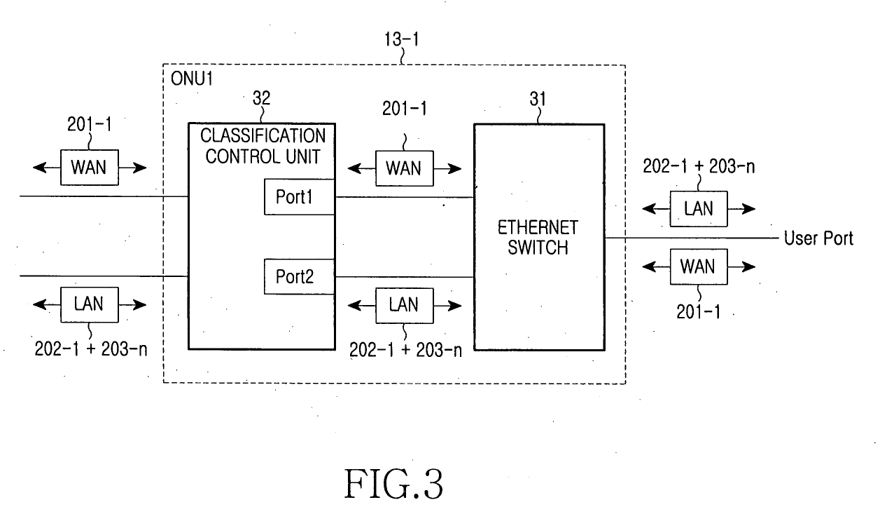

FIG. 3 is a view illustrating the detailed construction of an ONU in the EPON system which a local switching method using an LLID is applied according to an embodiment of the present invention.

Referring to FIG. 3, the ONU in the EPON system, to which the local switching method using the LLID according to the present invention is applied, includes an Ethernet switch 31 for receiving and separating the LAN traffic 202-1 and the WAN traffic 201-1 inputted through the user port, and a classification control unit 32 for allocating the LLIDs according to the types of the traffic inputted from the Ethernet switch 31 through the respective ports, and transferring the traffic with the LLIDs allocated thereto to the OLT 12.

In particular, the classification control unit 32 may further include a control function of allocating the DBA weight values to a specified traffic and setting specified queues to the specified traffic in order to secure the QoS.

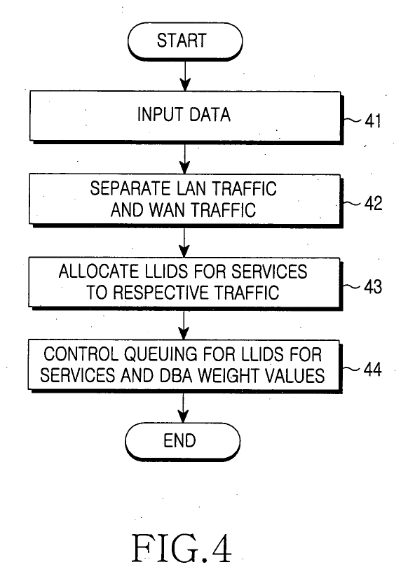

FIG. 4 is a flowchart illustrating a local switching method using an LLID of an ONU in an EPON system according to an embodiment of the present invention.

Referring to FIG. 4, in the EPON system to which the local switching method using the LLID is applied according to the present invention, the ONU receives the WAN traffic and the LAN traffic from a user port (41). Then, the ONU separates them into the WAN traffic and the LAN traffic according to the classification function (42).

Then, the ONU allocates LLIDs according to services for the respective traffic to the separated WAN traffic and LAN traffic (43).

Then, the ONU sets and transmits the queuing for the LLIDs for the respective services and the DBA weight values to the OLT (44).

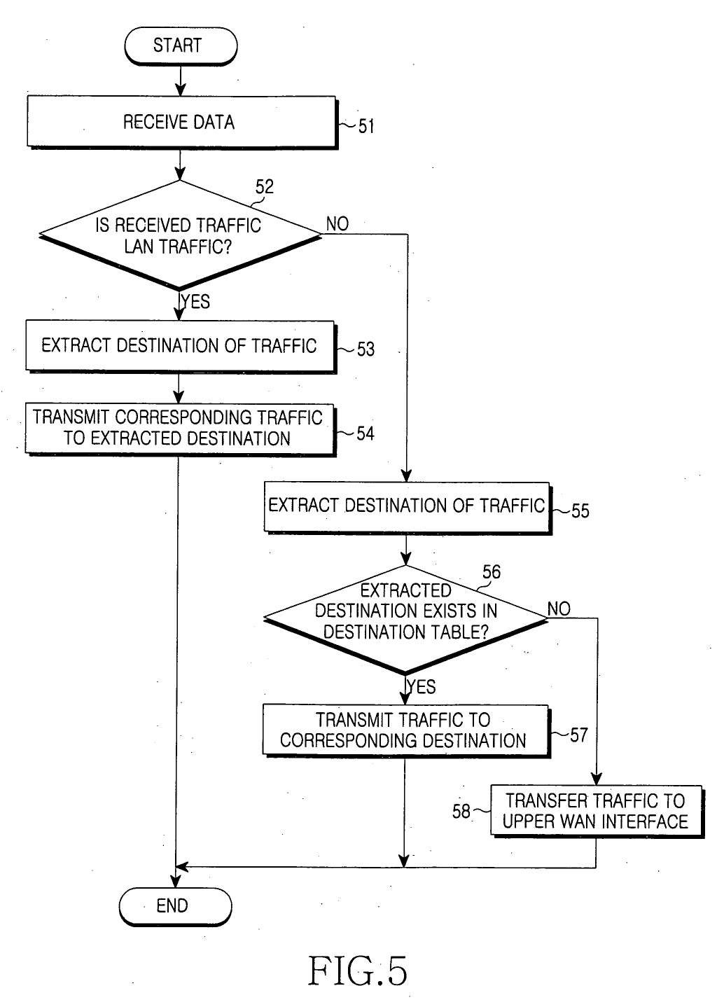

FIG. 5 is a detailed flowchart illustrating a local switching method using an LLID of an OLT in an EPON system according to an embodiment of the present invention.

As illustrated in FIG. 5, in the EPON system to which the local switching method using the LLID is applied according to the present invention, the OLT receives traffic data composed of the WAN traffic and the LAN traffic from the ONU (51).

Then, the OLT confirms whether the received traffic is the LAN traffic, and if the received traffic is the LAN traffic as a result of confirmation, it extracts the destination of the corresponding traffic (53), and transmits the corresponding traffic to the extracted destination with reference to a built-in destination routing table (54). Here, the OLT applies a control function for securing the QoS such as the queuing according to the LLID from the ONU and the DBA weight value setting to the traffic to perform a down-transmission of the traffic.

If the received traffic is not the LAN traffic as a result of confirmation, the OLT extracts the destination of the corresponding traffic (55), and confirms whether the extracted destination exists in the built-in destination routing table (56). If the corresponding destination exists, the OLT transmits the corresponding traffic to the corresponding destination (57). If no corresponding destination exists, the OLT transmits the corresponding traffic to an upper WAN interface (58).

Through the above-described operation, the local switching operation for switching and transmitting the LAN traffic transferred from the ONU to the ONU in the same OLT is performed. The inventive operation can be performed through a softwired process without the necessity of a new construction. Accordingly, the local switching operation according to the present invention can be achieved only by upgrading the software of the EPON system.

As described above, according to the present invention, the local switching function can be implemented only by changing the software in the EPON system by allocating the LLIDs to the respective traffic. In addition, the present invention can secure the QoS for the traffic according to the local switching function using internal software of the EPON system.

It should be noted that the method according to the present invention as described above may be implemented by a program and stored in a recording medium (such as a CD-ROM, RAM, floppy disk, hard disk, optomagnetic disk, and others) in a computer-readable form.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A local switching method using a logical link ID (LLID) in an Ethernet passive optical network (EPON) system, the method comprising:
a first step of an optical network unit (ONU) separating data inputted through a user port into a wide area network (WAN) traffic and a local area network (LAN) traffic, allocating the LLID according to a service for each traffic to the separated WAN traffic and LAN traffic, and transmitting the WAN traffic and LAN traffic with the LLIDs allocated thereto; and
a second step of an optical line termination (OLT) receiving the WAN traffic and LAN traffic with the LLIDs allocated thereto transferred from the ONU, extracting a destination of the corresponding traffic through the LLIDs, and transmitting the respective traffic accordingly.

2. The local switching method as claimed in claim 1, wherein the first step comprises:
a third step of the ONU receiving the data through the user port;
a fourth step of separating the input data into a WAN traffic and a LAN traffic according to a classification function of the ONU;
a fifth step of allocating the LLIDs according to services for the respective traffic to the separated WAN traffic and LAN traffic; and
a sixth step of performing a service performance control with respect to the respective traffic according to the LLIDs and transmitting the traffic to the OLT by performing a service performance control.

3. The local switching method as claimed in claim 2, wherein the service performance control according to the LLIDs in the sixth step is to control the service performance of the traffic by extracting the LLIDs for the respective services and allocating a queue to the traffic having the specified LLID.

4. The local switching method as claimed in claim 2, wherein the service performance control according to the LLIDs in the sixth step is to control the service performance of the traffic by extracting the LLIDs for the respective services and setting a weight value for a dynamic bandwidth allocation with respect to the traffic having the specified LLID.

5. The local switching method as claimed in claim 1, wherein the second step comprises:
a seventh step of the OLT receiving traffic data composed of the separated WAN traffic and LAN traffic from the ONU;
an eighth step of confirming whether the traffic received in the seventh step is the LAN traffic;
a ninth step of extracting a destination of the corresponding traffic if the received traffic is the LAN traffic as a result of confirmation, and transmitting the corresponding traffic to the extracted destination with reference to a built-in destination routing table; and
a tenth step of extracting the destination of the corresponding traffic if the received traffic is not the LAN traffic as a result of confirmation, confirming whether the extracted destination exists in the built-in destination routing table, and transmitting the corresponding traffic accordingly.

6. The local switching method as claimed in claim 5, wherein in the tenth step, the destination of the corresponding traffic is extracted if the received traffic is not the LAN traffic as a result of confirmation, it is confirmed whether the extracted destination exists in the built-in destination routing table, the corresponding traffic is transmitted to the corresponding destination if the corresponding destination exists in the table, and the corresponding traffic is transferred to an upper WAN interface if the corresponding destination does not exist.

7. The local switching method as claimed in claim 5, wherein in transmitting the LAN traffic in the ninth step, the LAN traffic is transmitted by performing a service performance control according to the LLID of the corresponding traffic.

8. The local switching method as claimed in claim 7, wherein the service performance control according to the LLID of the corresponding traffic is to control the service performance of the traffic by seizing the LLIDs for the respective services and allocating a queue to the traffic having the specified LLID.

9. The local switching method as claimed in claim 7, wherein the service performance control according to the LLID of the corresponding traffic is to control the service performance of the traffic by extracting the LLIDs for the respective services and setting a weight value for a dynamic bandwidth allocation with respect to the traffic having the specified LLID.

10. A method for performing a local switching in an Ethernet passive optical network (EPON) system in communication with a wide area network (WAN) and a local area network (LAN), the method comprising:
separating, by an optical network unit (ONU), an WAN data and an LAN data inputted through a user port according to a classification function of the ONU;
allocating a logical link ID (LLID) to the separated WAN and LAN data; and
upon receipt of the WAN and LAN data with the LLIDs allocated thereto, extracting, by an optical line termination (OLT), a destination of the corresponding data using the LLIDs for a subsequent transmission.

11. The method as claimed in claim 10, further comprising performing a service performance control with respect to the WAN and LAN data according to the LLIDs allocated thereto by allocating a queue to the respective WAN and LAN data.

12. The method as claimed in claim 11, wherein the service performance control is performed by extracting the LLIDs from the WAN and LAN data and setting a weight value for a dynamic bandwidth allocation with respect to the WAN and LAN data.

13. The method as claimed in claim 10, wherein the extracting comprises determining, by the OLT, if the LAN data is received; if so, extracting a destination of the corresponding data and transmitting the corresponding data to the extracted destination in accordance with a predetermined destination routing table; and otherwise, transmitting the corresponding data to an upper WAN interface.

14. A computer system including a memory, and a processor coupled to the memory, the processor configured to perform a local switching in an Ethernet passive optical network (EPON) system in communication with a wide area network (WAN) and a local area network (LAN), the memory having stored therein sequences of instructions which, when executed by the processor, cause the processor to:
separate an WAN data and an LAN data inputted through a user port according to a classification function of the ONU;
allocate a logical link ID (LLID) to the separated WAN and LAN data; and
upon receipt of the WAN and LAN data with the LLIDs allocated thereto, extract a destination of the corresponding data using the LLIDs for a subsequent transmission.

15. The computer system as claimed in claim 14, wherein the processor is further configured to perform a service performance control with respect to the WAN and LAN data according to the LLIDs allocated thereto by allocating a queue to the respective WAN and LAN data.

16. The computer system as claimed in claim 15, wherein the processor performs the service performance control by extracting the LLIDs from the WAN and LAN data and setting a weight value for a dynamic bandwidth allocation with respect to the WAN and LAN data.

17. The computer system as claimed in claim 14, wherein the extracting comprises determining, by the OLT, if the LAN data is received; if so, extracting a destination of the corresponding data and transmitting the corresponding data to the extracted destination in accordance with a predetermined destination routing table; and otherwise, transmitting the corresponding data to an upper WAN interface.
